(19) United States
(12) Patent Application Publication
(10) Pub. No.: US 2024/0234955 A1
(43) Pub. Date: Jul. 11, 2024

(54) ELECTROCHEMICAL CELL WITH SEALANT

(71) Applicant: Northvolt AB, Stockholm (SE)

(72) Inventors: Sang Eun CHEON, Stockholm (SE); Yong Kyoung KIM, Stockholm (SE); Nicolas POTIN, Västerås (SE); Valeria DE VELASCO BERMUDEZ, Västerås (SE); Billy GRUNDSTRÖM, Uppsala (SE)

(21) Appl. No.: 18/558,853

(22) PCT Filed: May 11, 2022
(86) PCT No.: PCT/EP2022/062853

§ 371 Date: Nov. 3, 2023

(30) Foreign Application Priority Data
May 12, 2021 (EP) 21173700.2

(51) Int. Cl. H01M 50/46; H01M 50/204

(52) U.S. Cl. CPC H01M 50/461; H01M 50/204

(57) ABSTRACT

The present disclosure relates to an electrochemical cell having a stacked configuration and to a battery module comprising a plurality of said electrochemical cell, the cell comprising a positive electrode and a negative electrode, a separator arranged therebetween, and a sealant disposed between the positive electrode and the negative electrode, which comprises first and second adhesive layers and first and second scaling layers.

### TECHNICAL FIELD

The present disclosure relates to an electrochemical cell having a stacked configuration and to a battery module comprising a plurality of said electrochemical cell, the cell comprising a positive electrode and a negative electrode, a separator arranged therebetween, and a sealant disposed between the positive electrode and the negative electrode, which comprises first and second adhesive layers and first and second sealing layers.

### BACKGROUND

Rechargeable or secondary batteries find widespread use as electrical power supplies and energy storage systems. For example, in automobiles, battery packs being formed of a plurality of battery modules, wherein each battery module includes a plurality of electrochemical cells, are expected as a means of effective utilization of electric power, also in the viewpoint of air pollution prevention. Several different form factors exist for the electrochemical cells applied in secondary batteries depending on their intended application field. In automotive applications, the most common cell types are cylindrical, prismatic and pouch cells. A further concept for automotive applications is large format flat, thin cells, which in general include a single positive electrode and a single negative electrode and in which the upper and lower surfaces are formed by the current collector foils, which serve as cell housing and also act as the terminals for the cell. Such cells can be serially stacked with direct contact between the cell terminals, thereby eliminating the need for an outside can, bus bars, or other terminal attachments. However, in order to prevent short-circuiting, the current collector foils have to be sealed with a sealant, such as an adhesive. There is still a need for improvements to make electrochemical cells, in particular large format electrochemical cells, durable and stable, and thereby better usable in practice.

### SUMMARY

In view of the above-outline requirements, an object of the present invention is to provide an electrochemical cell and a battery module having long lifetime and high safety.

Furthermore, it is an object of the present invention to provide an electrochemical cell and a battery module which have high energy and performance, have a low weight, are of simple structure and allow reduced hardware costs and simplified production processes, and at the same time have long lifetime and high safety.

One or more of these objects may be achieved by an electrochemical cell and a battery module according to the independent claims. The independent claims and the claims depending therefrom can be combined in any technologically suitable and sensible way, thereby providing further embodiments of the invention. The description, particularly in relation to the drawing, provides further details characterizing the invention.

Disclosed herein is an electrochemical cell which comprises a positive electrode; a negative electrode; a separator arranged between the positive electrode and the negative electrode; and a sealant disposed between the positive electrode and the negative electrode, wherein the sealant comprises a first adhesive layer and a second adhesive layer, wherein the first adhesive layer is disposed at a peripheral edge of the positive electrode on an inward facing side of the positive electrode, and the second adhesive layer is disposed at a peripheral edge of the negative electrode on an inward facing side of the negative electrode; and wherein the sealant comprises a first sealing layer and a second sealing layer, wherein the first sealing layer is disposed on the first adhesive layer such that the first adhesive layer is sandwiched between the first sealing layer and the positive electrode, and the second sealing layer is disposed on the second adhesive layer such that the second adhesive layer is sandwiched between the second sealing layer and the negative electrode.

The sealant joins a periphery of the positive electrode to a periphery of the negative electrode and may hence be stacked between portions of the positive and the negative electrode that are aligned in the stacking direction. The present inventors advantageously found that by applying at least a two-layer sealant, i.e. an adhesive layer and a sealing layer, at the peripheral edge of each electrode, sufficient insulation and bonding strength can be provided to thereby ensure a stable and durable sealing and joining of the positive electrode and the negative electrode and to achieve high safety and long lifetime.

In an embodiment, at least one of the first adhesive layer and the second adhesive layer, preferably both layers, is disposed along the entire outer peripheral edge of the positive electrode and the entire outer peripheral edge of the negative electrode, respectively (i.e., along all four sides assuming a rectangular shape of the electrode substrates). By this, the bonding strength between the positive electrode and the negative electrode is further increased.

The first and second adhesive layers mainly function to provide sufficient adhesion of the sealant to the respective electrode. Accordingly, the first adhesive layer and the second adhesive layer each comprise an adhesive material, which may be the same or different, and is preferably selected from materials which exhibit adhesive properties and binding force sufficient to attach directly to the electrode and to ensure a strong and durable interfacial bond between the electrode and the adhesive layer. Preferred examples of suitable adhesive materials include, but are not limited to, polyolefins, for example, polyethylene or polypropylene, functionalized polyolefins, for example, ethylene- or propylene copolymers with monomers containing one or more of carboxylate, epoxy, nitrile, imine, maleicanhydride and hydroxyl functional groups, polyvinyl alcohols, polyamides, polyacrylnitrile, epoxy resins, (meth)acrylates, and derivatives thereof.

In an embodiment, the first adhesive layer and the second adhesive layer comprise the same adhesive material, in order to simplify production processes.

A thickness of the first adhesive layer and a thickness of the second adhesive layer may be the same or different. Preferably the first adhesive layer and the second adhesive layer have the same thickness. In a preferred embodiment, the first adhesive layer and the second adhesive layer each have a thickness of less than or equal to 40 μm, preferably in the range of 0.5 μm to 40 μm, more preferably in the range of 15 μm to 40 μm. By this, the overall weight and thickness of the electrochemical cell and the battery module can be decreased, and material costs can be saved.

The first and second sealing layers mainly function to provide good sealing properties to the sealant. Accordingly, the first sealing layer and the second sealing layer each comprise a sealing material, which may be the same or different, and is preferably selected form materials that exhibit insulation properties, stickiness, especially when heated, and chemical resistance, especially against degradation by the electrolyte. In a preferred embodiment, the first sealing layer and the second sealing layer comprise the same sealing material, in order to simplify production processes.

In a preferred embodiment, the first sealing layer and the second sealing layer each comprise as a sealing material one or more selected from polyolefins, in particular polyethylene, polypropylene and cast polypropylene (CPP), functionalized polyolefins, in particular polyolefin copolymers with monomers containing one or more of carboxylate, epoxy, nitrile, imine, maleicanhydride and hydroxyl functional groups, and epoxy resins, wherein CPP is particularly preferred, as CPP has excellent insulation properties and high chemical resistance, and because it becomes sticky when heated. Particularly preferably, the first sealing layer and the second sealing layer each comprise at least CCP, and optionally one or more materials selected from polyolefins, in particular polyethylene or polypropylene, functionalized polyolefins, in particular polyolefin copolymers with monomers containing one or more of carboxylate, epoxy, nitrile, imine, maleicanhydride and hydroxyl functional groups, and epoxy resins. That is, in a further preferred embodiment, the first sealing layer and the second sealing layer each comprise, or consist of, CCP. In another further preferred embodiment, the first sealing layer and the second sealing layer each comprise, or consist of, CCP and one or more materials selected from polyolefins, in particular polyethylene or polypropylene, functionalized polyolefins, in particular polyolefin copolymers with monomers containing one or more of carboxylate, epoxy, nitrile, imine, maleicanhydride and hydroxyl functional groups, and epoxy resins.

A thickness of the first sealing layer and a thickness of the second sealing layer may be the same or different. Preferably the first sealing layer and the second sealing layer have the same thickness. In a preferred embodiment, the first sealing layer and the second sealing layer each have a thickness in the range of 20 μm to 200 μm, more preferably in the range of 30 μm to 150 μm, and even more preferably in the range of 40 μm to 80 μm. For example, each layer may have a thickness of 40 μm, or 80 μm. If the thicknesses of the first and second sealing layer are below this range, sealing performance during cycling may not be ensured and electrolyte leakage may occur. If the thicknesses are above the defined range, the cell becomes too thick so that the overall battery module dimension is affected. In a further preferred embodiment, the thickness of the first sealing layer is greater than the thickness of the first adhesive layer and/or the thickness of the second sealing layer is greater than the thickness of the second adhesive layer. By this configuration, it is possible to take advantage of the good sealing properties imparted by the sealing material, while at the same time sufficient adhesion to the electrodes is ensured.

In a further embodiment, the first sealing layer has substantially (i.e., within the given error limits of the production process) the same width as the first adhesive layer, measured from the outer peripheral edge to the inner peripheral edge of the first sealing layer and perpendicular to the stacking direction of the cell. Likewise, the second sealing layer has substantially the same width as the second adhesive layer, measured from the outer peripheral edge to the inner peripheral edge of the second sealing layer and perpendicular to the stacking direction of the cell, which is preferably the same width as the width of the first sealing layer.

In an embodiment, at least one of the first sealing layer and the second sealing layer has an inner peripheral edge that surrounds the separator at an outer peripheral edge of the separator. This means, the inner peripheral edge of at least one of the first sealing layer and the second sealing layer, preferably of both sealing layers, surrounds and directly contacts the outer peripheral edge of the separator, whereby the separator is sealed relative to the positive electrode and the negative electrode in order to properly isolate the positive electrode and the negative electrode. This configuration allows the cell to be thinner.

In another embodiment, in order to seal the separator relative to the positive electrode and the negative electrode and to properly isolate the positive electrode and the negative electrode, the separator at least partly extends through the first sealing layer and the second sealing layer such that the separator is sandwiched at an outer peripheral edge thereof between the first sealing layer and the second sealing layer. For example, the separator can entirely extend through the first sealing layer and the second sealing layer, such that the first and second sealing layers are completely separated from each other by the separator and such that they sandwich the separator at the outer peripheral edge thereof over their entire width (i.e. from their outer peripheral edge to their inner peripheral edge). Alternatively, the separator extends through the first sealing layer and the second sealing layer only to a certain extent, such that the first and second sealing layers sandwich the separator at the outer peripheral edge thereof only over a part of their width (i.e. from their inner peripheral edge to the outer peripheral edge of the separator).

In an embodiment, at least one of the first sealing layer and the second sealing layer, preferably both sealing layers, has an outer peripheral edge that protrudes outward relative to a peripheral edge of the positive electrode and the negative electrode. By this configuration, the outer edges of the positive electrode and the negative electrode can be prevented from coming into contact, thereby providing additional protection against short-circuiting. For example, according to this embodiment one or both of the first and second sealing layer may extend to the outside of the positive and/or negative electrode, in order to provide additional insulation when assembling two or more of the electrochemical cells into a battery pack or module.

In an embodiment, at least a portion of the positive and/or negative electrode may protrude laterally beyond the sealant arranged at the peripheral region of said electrodes. The protruding electrode portion may hence form an overhang, or extension, protruding from the sealant in a direction orthogonal to the stacking direction. One or both electrodes may protrude on one or several sides for the cell. In an example, the positive and the negative electrode may protrude from different sides of the cell, such as opposing sides, to allow the cell to be electrically accessed from different sides. The protruding electrode portion(s) may be formed of the entire edge of the electrode facing that particular side of the cell or be cut into one or several tab portions. The protruding electrode portion(s) may for example be used as a current collector acting as a terminal of the cell, or as a voltage pickup means for a battery management system (BMS) or the like. In an embodiment, the protruding portions of two or more cells arranged in a stack may be connected to each other to provide a parallel connection between the cells. The stack may hence comprise a combination of series and parallel connected cells.

As outlined above, by applying at least a two-layer sealant at the peripheral edge of each electrode, i.e., an adhesive layer and a sealing layer, a stable and durable sealing and joining of the positive electrode and the negative electrode is ensured. This arrangement is therefore particularly suitable for providing a single-layer, flat, large format electrochemical cell in which the upper and lower surfaces are electrically isolated and act as positive and negative terminals for the cell.

Therefore, according to a preferred embodiment of the electrochemical cell, the cell is a single-layer, large format electrochemical cell including a single positive electrode, a single negative electrode, which serve as a cell housing, a separator arranged between the single positive electrode and the single negative electrode, and a sealant disposed between the positive electrode and the negative electrode as describe above. According to a further preferred embodiment, the single positive electrode includes a first foil substrate, which may be formed of a first electrically-conducive material, and a first active material layer disposed on an inward facing side of the first foil substrate, and the single negative electrode includes a second foil substrate, which may be formed of a second electrically-conducive material, and a second active material layer disposed on an inward facing side of the second foil substrate, wherein the outward facing sides of the electrode substrates act as the negative and positive cell terminals, respectively.

Advantageously, due to the large surface area of such a cell a large capacity in a single electrode pair is ensured. Also, because of the large surface area heat is efficiently released from the cell and heat generation is prevented, thereby increasing safety and life time of the cell. Further, since the electrochemical cell according to this embodiment includes a single pair of electrodes of one positive electrode and one negative electrode, the structure and the production process becomes less complex, and material and production cost are reduced.

Further advantageously, such cells can be serially stacked with direct contact between the cell terminals, thereby eliminating the need for an outside can or cell housing, bus bars, or other terminal attachments. Additionally, since the direct contact occurs immediately adjacent to the active material sites, cell resistance is greatly reduced. In case two or more of the cells comprises electrodes with overhanging portions, i.e., terminal portions that protrude beyond the sealant and towards the lateral side of the cells, these portions may be utilised to provide parallel connections between cells in the stack.

Also disclosed herein is a battery module that comprises a plurality of electrochemical cells according to the present disclosure, i.e., at least two, preferably more than two, electrochemical cells according to the present disclosure.

In a preferred embodiment, the battery module comprises a plurality of single-layer electrochemical cells according to the present disclosure, which are serially stacked with direct contact to each other, such that there is direct contact between cell terminals of adjacent cells.

In the context of the present disclosure, the terms “large format cell” and “large surface area” may be understood as referring to cells having a width and/or length (as seen in a direction orthogonal to the stacking direction) in the order of magnitude of meters (m), or at least tenths of metres. Hence, a large format cell may refer to a cell having a minimum length and width in the range of, for instance, 0.3-2 m, such as 0.3×0.3 m, 0.6×0.6 m, 0.6×0.72 m, 0.8×0.8 m, 0.5×1.2 m, 1.2×1.5 m, and 1.5×2 m.

### BRIEF DESCRIPTION OF DRAWINGS

FIGS. 1 and 2 are side sectional views of electrochemical cells according to some embodiments of the present disclosure.

### DETAILED DESCRIPTION

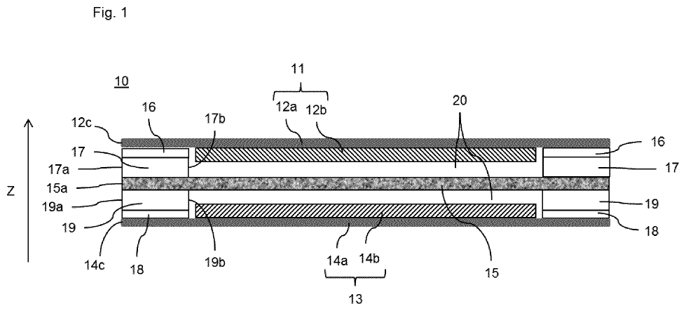

The technical solutions of the embodiments of this application will be described in more detail below with reference to the accompanying drawing indicated as FIG. 1, which shows merely an exemplary embodiment of this application. It is obvious that the embodiments to be described are a part rather than all of the embodiments of this application. The features of various embodiments can be combined to form further exemplary aspects of the present disclosure that may not be explicitly described or illustrated. All other embodiments obtained by persons of ordinary skill in the art based on the embodiments of the present invention without making creative efforts shall fall within the protection scope of the present disclosure.

FIG. 1 is a side sectional view of a single-layer electrochemical cell according to an embodiment of the present disclosure.

FIG. 1 schematically shows a single-layer electrochemical cell 10, which is for example a lithium ion cell, comprising a single positive electrode 11 and a single negative electrode 13 each having a layered structure; and a separator 15 disposed between the single positive electrode 11 and the single negative electrode 13. The positive electrode 11, the negative electrode 13 and the separator 15 are arranged in a stacked configuration, that is, in a single positive electrode-separator-single negative electrode stack. A sealant formed of first and second adhesive layers 16, 18 and first and second sealing layers 17, 19 joins a periphery of the positive electrode 11 to a periphery of the negative electrode 13. The voids 20 indicated in FIG. 1 may be filled with a liquid electrolyte.

The single positive electrode 11 (that is, the cathode) includes a first foil substrate 12a, which may be formed of a first electrically conductive material, and a first active material layer 12b disposed on an inward facing side of the first foil substrate 12a (that is, a side facing the separator 15 and the negative electrode 13 in the cell stack). The first foil substrate 12a preferably is a metal foil substrate formed of a first electrically conductive material such as aluminum, without being limited thereto. The first active material layer 12b preferably comprises a first active material selected from a lithiated metal oxide, and in particular from a lithium transition metal composite oxide, wherein the metal preferably includes one or more of nickel (Ni), cobalt (Co) and manganese (Mn). According to a preferred example, the positive electrode 11 is formed of an aluminum foil and has an active material layer comprising a lithium transition metal composite oxide disposed on the inward facing side. In embodiments, the first electrically conductive material of the first foil substrate 12a may be coated on one or both sides thereof with an oxidation-preventing metal, such as chromium. In further embodiments, a conductive material layer may additionally be disposed on an inward facing side of the first foil substrate 12a, such that the conductive material layer is sandwiched between the first foil substrate 12a and the first active material layer 12b, in order to enhance cell performance.

The single negative electrode 13 (that is, the anode) includes a second foil substrate 14a, which may be formed of a second electrically conductive material and a second active material layer 14b disposed on an inward facing side thereof (that is, a side facing the separator 15 and the positive electrode 11 in the cell stack). The second foil substrate 14a preferably is a metal foil substrate formed of a second electrically conductive material such as copper or copper-clad aluminum, without being limited thereto. The second active material layer 14b preferably comprises a second active material selected from graphite or silicon, or mixtures thereof. According to a preferred example, the negative electrode 13 is formed of a copper foil and has an active material layer comprising graphite disposed on the inward facing side. In embodiments, the second electrically conductive material of the second foil substrate 14a can be coated on one or both sides thereof with an oxidation-preventing metal, such as chromium.

The outward facing sides of first and second foil substrates 12a, 14a can act as the negative and positive cell terminals, respectively.

The first active material layer 12b and the second active material layer 14b preferably are not applied such that they cover the entire inward facing sides of the first foil substrate 12a and the second foil substrate 14a, respectively. As shown in FIG. 1, the first active material layer 12b is applied only to a central region of the first foil substrate 12a, such that a region exists at the outer peripheral edge 12c of the first foil substrate 12a, which is free of the first active material (i.e., a region onto which the first active material layer 12b is not applied). Likewise, the second active material layer 14b is applied only to a central region of the second foil substrate 14a, such that a region exists at the outer peripheral edge 14c of the second foil substrate 14a, which is free of the second active material (i.e., a region onto which the second active material layer 14b is not applied).

A first adhesive layer 16 is disposed at the outer peripheral edge 12c of the first foil substrate 12a on an inward facing side thereof (i.e., a side facing the separator 15 and the second foil substrate 14a in the cell stack). A second adhesive layer 18 is disposed at the outer peripheral edge 14c of the second foil substrate 14a on an inward facing side thereof (i.e., a side facing the separator 15 and the first foil substrate 12a in the cell stack). The first adhesive layer 16 and the second adhesive layer 18 attach directly to the first foil substrate 12a and the second foil substrate 14a, respectively. According to the embodiment of FIG. 1, the first adhesive layer 16 is applied to the inward facing side of first foil substrate 12a only at the region within the outer peripheral edge 12c of the first foil substrate 12a that is free of the first active material. Likewise, the second adhesive layer 18 is applied to the inward facing side of second foil substrate 14a only at the region within the outer peripheral edge 14c of the second foil substrate 14a which is free of the second active material 14b.

Preferably, the first adhesive layer 16 and the second adhesive layer 18 are applied along the entire outer peripheral edge 12c of the first foil substrate 12a and the entire outer peripheral edge 14c of the second foil substrate 14a, respectively (i.e., along all four sides assuming a rectangular shape of the electrode substrates). By this, the bonding strength between the first foil substrate 12a and the second foil substrate 14a is further increased.

Further preferably, the first adhesive layer 16 and the second adhesive layer 18 each has a thickness measured in the stacking direction Z of the cell of less than or equal to 40 μm, for example in the range of 0.5 μm to 40 μm, more preferably in the range of 15 μm and 40 μm. By this, the overall weight and thickness of the electrochemical cell and the battery module can be decreased, and material costs can be saved.

The first and second adhesive layers 16, 18 mainly function to provide sufficient adhesion of the sealant to the first and second foil substrates 12a, 14a. Accordingly, the first adhesive layer 16 and the second adhesive layer 18 may each comprise a material, which may be the same or different, with adhesive properties and binding force sufficient to attach directly to the electrode substrates, and which can ensure a strong and durable interfacial bond between the electrode substrates and the adhesive layers. More preferably, the first adhesive layer 16 and the second adhesive layer 18 comprise the same adhesive material to simplify production processes.

Preferred examples of suitable adhesive materials include, but are not limited to, polyolefins (for example, ethylene- or propylene-based polymers), functionalized polyolefins (for example, ethylene- or propylene copolymers with monomers containing one or more of carboxylate, epoxy, nitrile, imine, maleicanhydride and hydroxyl functional groups), polyvinyl alcohols, polyamides, polyacrylnitrile, epoxy resins, (meth)acrylates, and derivatives thereof.

Referring to FIG. 1, a first sealing layer 17 is disposed on the first adhesive layer 16 such that the first adhesive layer 16 is sandwiched between the first sealing layer 17 and the first foil substrate 12a, and a second sealing layer 19 is disposed on the second adhesive layer 18 such that the second adhesive layer 18 is sandwiched between the second sealing layer 19 and the second foil substrate 14a. The first sealing layer 17 and the second sealing layer 19 attach directly to the first adhesive layer 18 and the second adhesive layer 19, respectively.

The first and second sealing layers 17, 19 mainly function to provide good sealing properties to the sealant. Accordingly, the first sealing layer 17 and the second sealing layer 19 may each comprise a material, which may be the same or different, and which exhibits insulation properties, stickiness, especially when heated, and chemical resistance, especially against degradation by the electrolyte. Preferably, the first sealing layer 17 and the second sealing layer 19 comprise the same sealing material to simplify production processes.

Further preferably, the first sealing layer 17 and the second sealing layer 19 each comprise as the sealing material one or more selected from polyolefins, in particular polyethylene, polypropylene and cast polypropylene (CPP), functionalized polyolefins, in particular polyolefin copolymers with monomers containing one or more of carboxylate, epoxy, nitrile, imine, maleicanhydride and hydroxyl functional groups, and epoxy resins, wherein CPP is particularly preferred, because CPP has excellent insulation properties and high chemical resistance, and because it becomes sticky when heated. Particularly preferably, the first sealing layer 17 and the second sealing layer 19 each comprise at least CCP as sealing material, and optionally one or more materials selected from polyolefins, in particular polyethylene or polypropylene, functionalized polyolefins, in particular polyolefin copolymers with monomers containing one or more of carboxylate, epoxy, nitrile, imine, maleicanhydride and hydroxyl functional groups, and epoxy resins. That is, in an exemplary embodiment, the first sealing layer 17 and the second sealing layer 19 each comprise, or consist of, a CCP layer. In another exemplary embodiment, the first sealing layer 17 and the second sealing layer 19 each comprise, or consist of, a CCP layer and one or more material layers selected from polyolefins, in particular polyethylene or polypropylene, functionalized polyolefins, in particular polyolefin copolymers with monomers containing one or more of carboxylate, epoxy, nitrile, imine, maleicanhydride and hydroxyl functional groups, and epoxy resins.

As shown in the embodiment of FIG. 1, the first sealing layer 17 has the same width as the first adhesive layer 16, and the second sealing layer 19 has the same width as the second adhesive layer 18, each measured from an outer peripheral edge 17a, 19a to an inner peripheral edge 17b, 19b of the sealing layers and perpendicular to the stacking direction Z of the cell. This is however only exemplary, and the first and second sealing layers 17, 19 can independently from each other have a greater or smaller width than the first and second adhesive layers 16, 18.

As further shown in the embodiment of FIG. 1, the thickness of the first sealing layer 17 is preferably greater than the thickness of the first adhesive layer 16, and the thickness of the second sealing layer 19 is preferably greater than the thickness of the second adhesive layer 18, each measured in measured in the stacking direction Z of the cell. By this configuration, it is possible to take advantage of the good sealing properties imparted by the sealing material, while at the same time sufficient adhesion to the electrodes is ensured.

Further preferably, the thickness of the first sealing layer 17 and the thickness of the second sealing layer 19, measured in the stacking direction Z of the cell, is each in the range of 20 μm to 200 μm, more preferably in the range of 30 μm to 150 μm, and even more preferably in the range of 40 μm to 80 μm, for example 40 μm, or 80 μm. Further preferably the first sealing layer and the second sealing layer have the same thickness. If the thickness of each of sealing layers 17, 19 is below this range, the sealing performance during cycling may not be ensured and electrolyte leakage may occur. If the thickness of each of sealing layers 17, 19 If is above this range, the cell becomes too thick so that the overall battery module dimension is affected.

According to another embodiment not shown in FIG. 1, at least one of outer peripheral edges 17a, 19a of the first sealing layer 17 and the second sealing layer 19, preferably both outer peripheral edges, protrudes outward relative to outer peripheral edges 12c, 14c of the first and second foil substrate 12a, 14a, respectively. By this configuration, the outer edges of the first and second foil substrate 12a, 14a, which act as the negative and positive cell terminals, can be prevented from coming into contact, thereby providing additional insulation and protection against short-circuiting. For example, according to this embodiment one or both of the first and second sealing layer 17, 19 may extend to the outside of the first and second foil substrate 12a, 14a, respectively, in order to provide additional insulation when assembling two or more cells 10 into a battery pack or module.

The first foil substrate 12a and first active material layer 12b are spaced apart and isolated from the second foil substrate 14a and second active material layer 14b by the separator 15. The separator 15 is not specifically limited, and is made of an electrically isolating and permeable material that isolates the positive electrode 11 from the negative electrode to prevent electrical short-circuiting and allows the passing through of ions provided in the electrolyte. For example, the separator 15 may have a 3-layer structure comprising for example a base film, which includes a polyolefin and a non-woven material, a ceramic layer coated on the base film, and a layer including polyvinylidenfluorid and acrylate binder coated on the ceramic layer.

As shown in the embodiment of FIG. 1, the separator 15 entirely extends through the first sealing layer 17 and the second sealing layer 19, such that the first and second sealing layers 17, 19 are completely separated from each other by the separator 15. According to this configuration, separator 15 is sandwiched at an outer peripheral edge 15a between the first and second sealing layers 17, 19 over their entire width (i.e. from their outer peripheral edge 17a, 19a to their inner peripheral edge 17b, 19b), whereby a seal exists between the first foil substrate 12a/first active material layer 12b of the positive electrode 11 and the separator 15, and between the second foil substrate 14a/second active material layer 14b of the negative electrode 13 and the separator 15. By this configuration, a hermetic seal about a periphery of the cell can be achieved to properly isolate the positive electrode 11 and the negative electrode 13.

The present disclosure is however not limited to this configuration. According to another embodiment not shown in FIG. 1, the separator 15 does not entirely extend through the first sealing layer 17 and the second sealing layer 19, but only to a certain extent.

According to this embodiment, the separator 15 is sandwiched at the outer peripheral edge 15a between the first and second sealing layers 17, 19 only over a part of their width (i.e. from their inner peripheral edge 17b, 19b to the outer peripheral edge 15a of the separator). This configuration likewise achieves a hermetic seal about a periphery of the cell proper to properly isolate the positive electrode 11 and the negative electrode 13.

According to still another embodiment not shown in FIG. 1, at least one of the first sealing layer 17 and the second sealing layer 19 has an inner peripheral edge 17b, 19b that surrounds an outer peripheral edge 15a of the separator 15. This means, the inner peripheral edge 17b, 19b of at least one of the first sealing layer 17 and the second sealing layer 19, preferably of both sealing layers, surrounds and directly contacts the outer peripheral edge 15a of the separator 15, whereby the separator 15 is sealed relative to the positive electrode 11 and the negative electrode 13 in order to properly isolate the positive electrode 11 and the negative electrode 13. This configuration allows the cell to be thinner.

By applying the two-layer sealant including first adhesive 16 and first sealing layer 17 and second adhesive 18 and second sealing layer 19 at the peripheral edge of first and second foil substrate 12a, 14a, respectively, as shown for example in FIG. 1, a stable and durable sealing and joining of the positive and negative electrodes 11, 13 is ensured, as the adhesive layers provide a strong bonding to the electrode substrates and the sealing layers provide good insulation properties and high chemical resistance. By this safety and lifetime of the cell are increased. Further, by this the upper and lower surfaces of the cell are electrically isolated and can act as positive and negative terminals for the cell. Such cells can therefore be serially stacked with direct contact between the cell terminals, thereby eliminating the need for an outside can or cell housing, bus bars, or other terminal attachments. Advantageously, since the direct contact occurs immediately adjacent to the active material sites, cell resistance is greatly reduced.

Further, since the electrochemical cell according to the embodiment shown in FIG. 1 includes a single pair of electrodes of one positive electrode and one negative electrode, the structure and the production process becomes less complex, and material and production cost are reduced. Advantageously, due to the large surface area of the cell a large capacity in the single electrode pair is ensured. Additionally, because of the large surface area of the cell heat is efficiently released from the cell and heat generation is prevented, thereby increasing safety and life time of the cell. Examples of such large cells may have a largest lateral dimension in the range of 0.3-2 m. The cell may, for instance, be formed of electrodes having a rectangular or quadratic shape with sides measuring 0.3×0.3 m, 0.6×0.6 m, 0.6×0.72 m, 0.8×0.8 m, 0.5×1.2 m, 1.2×1.5 m, or 1.5×2 m. It will however be appreciated that the electrodes (and thus the resulting cell) may have other shapes as well, conforming to e.g., circles, ovals, or T-shapes.

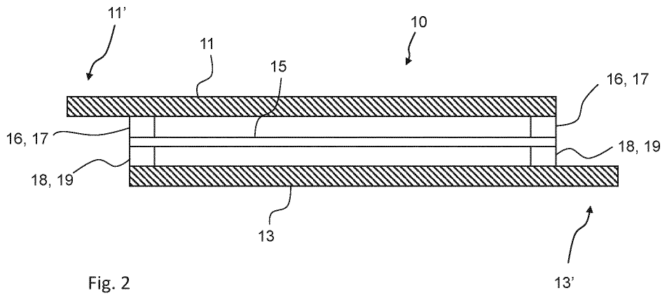

FIG. 2 is a side sectional view of a cell 10 according to an embodiment of the present disclosure, which may be similarly configured as the cell discussed above with reference to FIG. 1. The cell 10 may hence comprise a positive electrode 11 and a negative electrode 13, wherein each may have a layered structure (not shown), as well as a separator 15 disposed therebetween. A sealant 16, 17, 18, 19 may be arranged at the peripheral edges of the positive electrode 11 and the negative electrode 13, forming a stacked structure with the respective electrodes 11, 13. The sealant may be formed of a stack of adhesive and sealing layers as in FIG. 1, or a single layer.

As indicated in the present figure, at least a portion 11′, 13′ of the peripheral region of the positive and/or negative electrode 11, 13 may be arranged to protrude outwardly from the edge of the cell 10. The protruding electrode portion 11′, 13′ hence forms an overhang, or terminal extension, protruding from the sealant in a direction orthogonal to the stacking direction. The protruding portion 11′, 13′ may preferably be formed of a portion of the electrode that is not covered with any active material layer 12b, 14b as illustrated in FIG. 1. In the present example, each of the positive and the negative electrodes 11, 13 comprises a respective overhanging portion 11′, 13′ arranged to protrude on opposite sides of the cell 10. In different words, the lateral extension of the electrodes 11, 13 need not necessarily be defined by the position of the sealant at the peripheral edges, as indicated in FIG. 1. On the contrary, the electrodes 11, 13 may as well comprise at least one portion, such as a tab, that extends beyond the sealant to facilitate electrical access to the cell 10.

Although the invention has been described above with regard to its preferred embodiments, which represent the best mode for carrying out the invention, it is understood that various changes as would be obvious to one of ordinary skill in this art can be made without departing from the scope of the disclosure, which is set forth in the appended claims.

1. Electrochemical cell having a stacked configuration, comprising:
a positive electrode;
a negative electrode;
a separator arranged between the positive electrode and the negative electrode; and
a sealant disposed between the positive electrode and the negative electrode,
wherein the sealant comprises:
a first adhesive layer and a second adhesive layer, wherein the first adhesive layer is disposed at a peripheral edge of the positive electrode on an inward facing side of the positive electrode, and the second adhesive layer is disposed at a peripheral edge of the negative electrode on an inward facing side of the negative electrode; and
a first sealing layer and a second sealing layer, wherein the first sealing layer is disposed on the first adhesive layer such that the first adhesive layer is sandwiched between the first sealing layer and the positive electrode, and the second sealing layer is disposed on the second adhesive layer such that the second adhesive layer is sandwiched between the second sealing layer and the negative electrode.

2. The electrochemical cell according to claim 1, wherein at least one of the first adhesive layer and the second adhesive layer is disposed along the entire outer peripheral edge of the positive electrode and along the entire outer peripheral edge of the negative electrode, respectively.

3. The electrochemical cell according to claim 1, wherein the first adhesive layer and the second adhesive layer each have a thickness of less than or equal to 40 μm.

4. The electrochemical cell according to claim 1, wherein the first sealing layer and the second sealing layer each comprise a sealing material, which is the same or different, and is one or more selected from polyolefins.

5. The electrochemical cell according to claim 1, wherein the first sealing layer and the second sealing layer sealing each comprise cast polypropylene.

6. The electrochemical cell according to claim 1, wherein the first sealing layer and the second sealing layer sealing each consist of cast polypropylene.

7. The electrochemical cell according to claim 1, wherein the first sealing layer and the second sealing layer each have a thickness in the range of 20 μm to 200 μm.

8. The electrochemical cell according to claim 1, wherein the thickness of the first sealing layer is greater than the thickness of the first adhesive layer, and/or wherein the thickness of the second sealing layer is greater than the thickness of the second adhesive layer.

9. The electrochemical cell according to claim 1, wherein the first sealing layer has substantially the same width as the first adhesive layer, and wherein the second sealing layer has substantially the same width as the second adhesive layer.

10. The electrochemical cell according to claim 1, wherein at least one of the first sealing layer and the second sealing layer has an inner peripheral edge that surrounds the separator.

11. The electrochemical cell according to claim 1, wherein the separator at least partly extends through the first sealing layer and the second sealing layer, and is sandwiched at least in parts between the first sealing layer and the second sealing layer.

12. The electrochemical cell according to claim 1, wherein at least one of the first sealing layer and the second sealing layer has an outer peripheral edge that protrudes outward relative to an outer peripheral edge of the positive electrode and the negative electrode.

13. Battery module, comprising a plurality of electrochemical cells according to claim 1.

14. The battery module according to claim 13, wherein at least some of the plurality of electrochemical cells are serially stacked with direct contact to each other.

15. The battery module according to claim 14, wherein a first portion of the negative and/or positive electrode of a first one of the plurality of electrochemical cells and a second portion of the negative and/or positive electrode of a second one of the plurality of electrochemical cells protrude laterally beyond the sealant and are arranged to form an electrical parallel connection between the first and second ones of the plurality of electrochemical cells.

16. The electrochemical cell according to claim 4, wherein the polyolefins are one or more selected from polyethylene, polypropylene and cast polypropylene, or functionalized polyolefins.

17. The electrochemical cell according to claim 16, wherein the functionalized polyolefins are one or more selected from polyolefin copolymers with monomers containing one or more of carboxylate, epoxy, nitrile, imine, maleicanhydride and hydroxyl functional groups, and epoxy resins.

18. The electrochemical cell according to claim 5, wherein the cast polypropylene is one or more selected from polyethylene, polypropylene, polyolefin copolymers with monomers containing one or more of carboxylate, epoxy, nitrile, imine, maleicanhydride and hydroxyl functional groups, and epoxy resins.
